(19) United States
(12) Patent Application Publication
(10) Pub. No.: US 2024/0025031 A1
(43) Pub. Date: Jan. 25, 2024

(54) EXOSKELETON COMPRISING AN ELASTIC ELEMENT

(71) Applicant: Simon MASSONNIER, TARBES (FR)

(72) Inventor: Simon MASSONNIER, TARBES (FR)

(21) Appl. No.: 18/025,340

(22) PCT Filed: Sep. 7, 2021
(86) PCT No.: PCT/EP2021/074543

§ 371 Date: Mar. 8, 2023

(30) Foreign Application Priority Data
Sep. 8, 2020 (FR) 2009098

(51) Int. Cl. B25J 9/00; B25J 9/10

(52) U.S. Cl. CPC B25J 9/0006; B25J 9/109

(57) ABSTRACT

An exoskeleton comprising: —an arm comprising a means for attaching an upper limb, —a load-bearing structure comprising a support point, —a compensation member secured to said arm by a first pivot, extending between said arm and said load-bearing structure and exerting a compensation force moment on said arm by deformation of an elastic element, —a force transmission element extending between a lower point of the compensation member and a rear end of the arm, —the elastic element and said force transmission element being loaded in tension when using the exoskeleton, so that the moment varies with the inclination of the arm, —said transmission element is secured to the arm by a second pivot, the first pivot being located between the second pivot and the front end of the arm.

### TECHNICAL FIELD OF THE INVENTION

The field of the invention is that of exoskeletons, i.e. mechanical structures which partially double the human skeleton in order to assist him in carrying out a task or an activity, such as lifting and carrying a load.

By the term “load”, it should be understood in the present text, a weight supported by a user, i.e. the weight of his own upper limbs possibly added to the weight or a force exerted by one or more handled object(s).

More specifically, the invention relates to an exoskeleton comprising an elastic element generating a force moment to compensate for a load, so as to relieve the wearer of the exoskeleton in carrying out a task or activity.

In particular, the invention finds applications in the medical, military, and physical/manual work fields, in which the invention allows preventing in particular the apparition of musculoskeletal disorders.

### PRIOR ART

Exoskeleton techniques are known from the prior art allowing relieving the wearer when carrying out painful, repetitive tasks in particular involving the apparition of musculoskeletal disorders.

Exoskeleton techniques for medical and military purposes are also known from the prior art, intended to restore the physical performances of a physically weakened person, or to increase those of an able-bodied person.

Thus, exoskeleton solutions using various mechanical means, such as robotic means involving in particular actuator cylinders, are known.

In particular, the drawback of such robotic systems is their large mass, their considerable acquisition and maintenance cost, as well as the need for access to a source of energy, for example electric or hydraulic, which is generally heavy and cumbersome when it is embedded on the exoskeleton, and generally having a low autonomy.

Purely mechanical systems are also known, i.e. in particular comprising no electromechanical or hydromechanical actuator, and requiring no on-board energy source.

A large number of such systems are based in particular on the use of cables, pulleys or rods arranged so as to support the limbs of the wearer, the system being self-powered by storing the energy supplied from outside the system in the form of elastic energy, the storage being performed by the deformation of elastic elements during the movement of the limbs of the wearer.

Such systems allow suppressing part of the aforementioned drawbacks, however the known solutions of the prior art turn out to be cumbersome and include many elements that are detrimental to freedom of movement and ergonomics for the wearer.

In addition, the known systems generally withstand significant forces on their central components, requiring significant sizing increasing the mass of the exoskeleton, or requiring more frequent replacements of parts when an optimization of the mass is looked for.

None of the current systems allows simultaneously addressing all of the required needs, namely to propose a non-motorized and non-robotized exoskeleton technique meeting the criteria of reduced mass, cost, and size, while proposing a simple design and a long service life.

### DISCLOSURE OF THE INVENTION

The present invention aims to overcome all or part of the above-mentioned drawbacks of the prior art.

To this end, the invention relates to an exoskeleton adapted to assist, in use, at least one upper limb of a wearer of said exoskeleton when lifting and carrying a load, said exoskeleton comprising:
at least one arm including at one of its ends called “front end”, at least one means for attaching an upper limb of the wearer,
a load-bearing structure intended to be secured to the wearer including at least one support point,
at least one compensation member secured to said arm by a first pivot, extending between said arm and said load-bearing structure to which said member is secured, and exerting a compensation force moment on said arm by the deformation of at least one elastic element,
a force transmission element extending between a low point of the compensation member and an end called “rear end” of said arm opposite to the front end, the exoskeleton comprising:
the at least one elastic element and said force transmission element being continuously loaded in tension during use of the exoskeleton, and being configured so that the force moment varies with the inclination of the arm, and
said transmission element is secured to the arm by a second pivot located at the rear end of the arm, the first pivot being located between the second pivot and the front end of the arm.

Thanks to these arrangements, it is possible to provide an exoskeleton technique that is entirely self-powered, thanks to the storage of energy in the elastic element, and that being so with reduced mass and size, no energy storage reservoir being necessary.

In addition, the exoskeleton also offers assistance to the user consistent with the effort to be supplied, i.e. to supply a compensation effort, more specifically a compensation force moment, more significant in a working position, in which the user handles a load for example, and less significant when he is in a rest position, with the arms along the body towards his feet.

Since the exoskeleton extends between the waist of the user and his upper limb, the arm of the exoskeleton is located under the upper limb in use. Thus, the arm of the exoskeleton is stressed only in bending and not in bending and torsion as is the case in the known exoskeletons of the prior art, allowing achieving a greater longevity and also smaller dimensions. More specifically, sizing of an arm stressed in bending but not in torsion translates in a reduced profile, compared to an arm also stressed in torsion. In addition, a design of the arm made in composite materials is thus made possible, this type of materials having properties of high resistance to bending, but little resistance to torsion. For example, the use of materials comprising glass or carbon fibers is thus made possible, allowing obtaining an exoskeleton arm with a greatly reduced mass compared to known exoskeleton techniques.

In addition, the structure formed by the compensation member, the arm, and the force transmission element being self-stressed, i.e. the aforementioned elements as well as their components form a structure balancing under the set of compressive and tensile stresses. In particular, the force transmission element and the elastic element are loaded purely in tension, the other components of the compensation member and the arm being loaded in compression. The arm also including a point of application of the load, the latter is loaded in bending as mentioned hereinabove, the system of self-stressed elements thus not forming a so-called perfect “tensegrity” system, but being very close thereto. In particular, in the absence of load, the mass of the arm being able to be neglected, the system is in a quasi-tensegrity state. It should be understood that the equilibrium of the structure is dynamic, as it varies under the effect of the load, the elastic element (s) allowing reaching equilibrium by their variable tension.

The presence of a single elastic element allows obtaining a “basic” output behavior of the exoskeleton, the compensation force felt by the user varying in a sinusoidal manner, with a maximum felt at a so-called “working” position, and a minimum in “low” and “high” extreme positions.

However, the exoskeleton according to the invention may comprise a greater number of elastic elements, this number being theoretically unlimited. Indeed, it is possible to design a compensation member having a plurality of elastic elements in series or in parallel, allowing obtaining various output behaviors of the exoskeleton. In particular, it is possible to use elastic elements with different elastic constants, allowing varying the output behavior further.

In addition, the multiplication of elastic elements allows designing a compensation member with various shapes, in particular curvilinear, allowing following the line of the body of the user as closely as possible.

In addition, depending on the design of the exoskeleton, starting from extreme positions towards an intermediate position, the compensation force increases, preferably monotonically, in order to increasingly compensate for the load, which is increasingly difficult to wear or handle for the user. In this manner, the user feels a progressive support allowing carrying out fluid gestures. In particular, the force felt by the user follows a generally sinusoidal path, resulting in a high compensation in the positions around the working position, and lower in the extreme positions requiring only moderate compensation. Moreover, such an evolution of the compensation force according to the position of the upper limb corresponds to the evolution of the force exerted by an upper limb on the shoulder of the wearer, such that the exoskeleton compensates for the load represented by the upper limb, in all of its angular positions, so as to permanently relieve the wearer of the exoskeleton.

In particular embodiments of the invention, said arm includes a mechanism for setting the distance between said first pivot and second pivot.

Thanks to these arrangements, the lever arm on which the compensation force acts can be varied, thereby varying the available compensation force moment. Thus, in a very simple way, the user can adapt the output “power” of the exoskeleton according to the type of task or activity he wishes to carry out.

In particular embodiments of the invention, the setting mechanism comprises:
an opening of the first pivot in which the arm is able to slide,
a setting plate located at one of the ends of the arm, said plate being secured to a worm screw cooperating with a threaded opening of said pivot.

Thanks to these arrangements, setting is particularly simple to access and intuitive, allowing making the use of the exoskeleton possible for a wide range of users, with no specific training in the use of exoskeletons. It can also be carried out by the user alone, without assistance, and without having to pull off the exoskeleton, thereby allowing adapting the desired torque “in real-time”, according to the conditions of use of the exoskeleton.

In particular embodiments of the invention, the compensation member comprises an elastic element in
a minimum tension state when the upper limb is located in a so-called “high” first extreme position and
in maximum tension state when the upper limb is located in a so-called “rest” second extreme position, and
the tension of said elastic element causing a retraction of the compensation member, being in a deployed state and respectively in a maximum retracted state when the upper limb is located in the high, respectively rest*, position;

Thanks to these arrangements, the compensation member acts in compression on the arm of the exoskeleton while using an elastic element acting in tension, simpler than an element acting in compression.

The arm of the exoskeleton undergoes a force moment tending to make it pivot about a point of rotation towards the rest position. The compensation force (from which the compensation moment is derived) can be applied between the point of rotation and the point of application of the load through the use of a compensation member acting in compression. Conversely, many known systems of the prior art whose compensation member acts in tension are forced to apply the compensation force opposite the point of application of the load, thereby lengthening the length of the arm of the exoskeleton and increasing its size. Hence, such a design solves a hitherto insolvable problem, namely obtaining an exoskeleton with a compact arm, not significantly protruding from the body of the wearer, while using an elastic tension element, which is lighter, cheaper and smaller than an equivalent compression element.

In particular embodiments of the invention, the compensation member includes
an upper bar and
a lower bar, said bars being parallel and
an upper end of the lower bar being secured to an upper plate and
a lower end of the upper bar being secured to a lower plate,
   the upper, respectively lower, bar sliding in an opening of the upper, respectively lower, plate and said elastic element extending between the upper plate and the lower plate

Thanks to these arrangements, it is possible to make the exoskeleton according to the invention with components that are simple, inexpensive and easily obtainable on the market.

In addition, thanks to these provisions, the compensation member is both sufficiently rigid and simple in design. The kinematics thus created allows doubling the length of the compensation device in a deployed state.

In addition, a design using two parallel bars (or tubes) allows reducing the positions in which the cantilever on each of the bars is significant. Indeed, these positions are limited to a deployed position or a position close to the deployed position, in the remaining positions the upper and lower plates reduce the cantilever length of each of the bars, thereby greatly limiting the risk of buckling of the bars.

The known solutions of the prior art propose compensation bodies evolving beyond the upper limb in the direction of the shoulders of the user, and that being so often with a single bar or a single tube, whereas the design proposed by the present invention allows limiting the length of the compensation member to the distance separating the support point and the first pivot, i.e. approximately the distance separating the waist and the upper limb of the user. This distance being covered by two bars, and these being guided by plates, the risks of buckling are greatly reduced compared to the known prior art. Thus, it is possible to use bars or tubes with greatly reduced dimensions, allowing lightening the exoskeleton even more, compared to known solutions.

In particular embodiments of the invention, the at least one elastic element is an elastic cable including an elastic core, preferably made of rubber, and a protective sheath, preferably made of a woven material having an elastic capacity.

Thanks to these arrangements, the elastic element consists of an element that is particularly light, inexpensive and simple to obtain.

In particular embodiments of the invention, the force transmission element includes an elongated element substantially with no elastic deformation capacity.

In particular embodiments of the invention, the force transmission element includes two elongated elements extending parallel to one another on either side of the compensation member.

In this manner, the force transmission element is disposed on either side of the compensation member, making the design of the exoskeleton according to the invention particularly compact.

In particular embodiments of the invention, the elongate element is a cable.

Thanks to these arrangements, the exoskeleton according to the invention is particularly light, without sacrificing structural performances, the force transmission element being stressed only in tension and could be made using cables.

In particular embodiments of the invention, said support point is a spherical housing and the compensation member includes a spherical head, so as to form a ball-joint connection.

Thanks to these arrangements, the compensation member and the arm of the exoskeleton can perform rotations about all of the axes of space, allowing preserving the freedom of movement of the upper limb of the user.

In particular embodiments of the invention, said load-bearing structure is a pelvic belt adapted to grip the hips and/or the waist of the wearer.

Thanks to these arrangements, the exoskeleton is held on the user at an area of the body allowing taking up significant efforts, and thus contributes in lowering the risk of injuries or the apparition of musculoskeletal disorders.

It should also be pointed out that the exoskeleton is held on the user only at his waist/his hips, and at his upper limb, but that no other support means, in particular at the shoulders, for example via braces, is necessary.

In particular embodiments of the invention, said attachment means includes a longitudinal cushion, the projections of the axis of said cushion and of the axis of the arm on a so-called “horizontal” plane intersecting according to an angle comprised between 0 and 30 degrees, when the exoskeleton is located in a so-called “working” position.

Thanks to these arrangements, the exoskeleton does not present any risk of collision with the flanks and armpits of the user, thereby increasing the safety and the comfort of use of the exoskeleton.

Thus, it is also possible for the user to perform movements of more than 90° to his right and to his left, in the working position, the risk of collision of the exoskeleton with the user being suppressed thanks to the aforementioned arrangements.

### BRIEF DESCRIPTION OF THE FIGURES

Other advantages, aims and particular features of the present invention will arise from the following nonlimiting description of at least one particular embodiment of the devices and methods objects of the present invention, with reference to the appended drawings, wherein:

FIG. 1 is a schematic perspective view of the exoskeleton according to the invention worn by the user.

FIG. 2 is a schematic perspective view of the isolated exoskeleton in the so-called “working” position.

FIG. 3 is a schematic perspective view of the isolated exoskeleton in the so-called “rest” position.

FIG. 4 is a schematic perspective view of the isolated exoskeleton in the so-called “high” position.

FIG. 5 is a graph of the evolution of the compensation force as a function of the angle of inclination of the arm with respect to the horizontal.

FIG. 6 is a top view of the exoskeleton in a so-called “working” position.

FIG. 7 is a perspective view of the exoskeleton in a so-called “working” position, the user spreading his arms without the arms of the modules colliding with his sides.

### DETAILED DESCRIPTION OF THE INVENTION

This description is given without limitation, each feature of an embodiment being able to be advantageously combined with any other feature of any other embodiment.

As of now, it should be noted that the figures are not to scale.

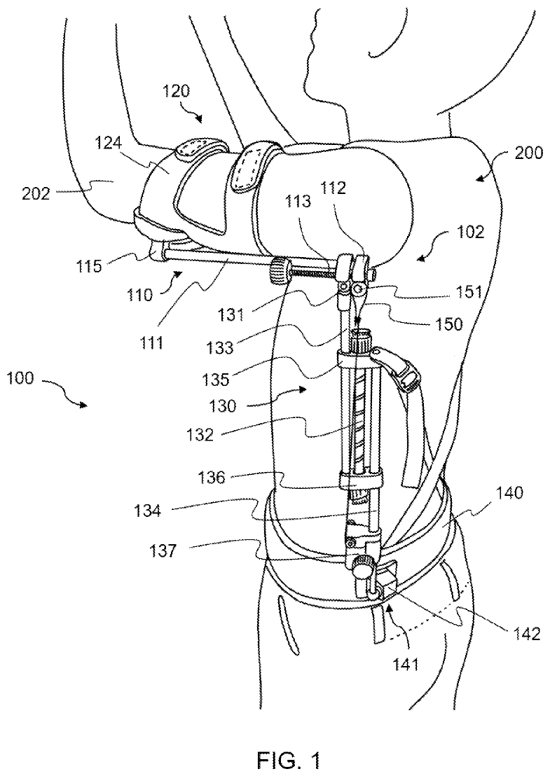

The present invention relates to an exoskeleton 100, represented in FIG. 1, in a state where the latter is worn by an individual 200, hereinafter also referred to as “user” or “wearer”. It should be specified that although the exoskeleton 100 generally comprises a right module 101, adapted to relieve a right upper limb 201 of the user, and a left module 102, adapted to relieve a left upper limb 202 of the user, for brevity, reference will be made later on only to one of the two modules, namely the left module 102, and the term “left” will also be omitted for brevity. It is also specified that the two right 101 and left 102 modules are identical or similar from a structural point of view, and are symmetrical with respect to the wearer.

It is also possible to make an exoskeleton 100 comprising only one, right or left, module depending on the desired application, or depending on the physical characteristics of the user.

As illustrated in FIG. 1, each module of the exoskeleton is intended to relieve the corresponding upper limb, i.e. reduce the physical effort supplied by the user, resulting in a muscular activity, and therefore in particular a lower cardiac and respiratory activity. In this manner, the user is subjected to less physically exhausting activity conditions, allowing preserving the health of the user.

Conversely, it is however also possible to increase the physical capabilities of the user, with equal physical effort (compared to an activity without an exoskeleton according to the invention). In other words, it is possible to increase the force with which the user can lift, carry or handle a load, i.e., conversely, reduce the weight of the load felt by the user.

More specifically, the force generated by the load on the exoskeleton (not represented in FIG. 1) corresponds primarily to the weight of the load.

It should be easily understood that this load exerts efforts in the form of forces and moments on the exoskeleton, the efforts exerted by the load tending to act against the efforts of the user 200. Thus, the main function of the exoskeleton is to act against these forces exerted by the load and to support the efforts of the user 200.

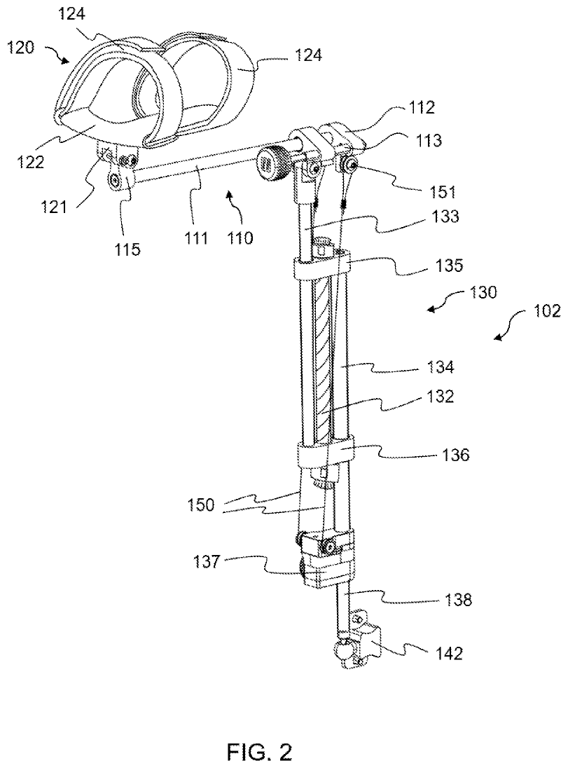

FIG. 2 represents the left module 102 comprising an arm 110, in a so-called “working” or “intermediate” position, in which the arm 110 is generally horizontal, the left upper limb of the user 200 also being generally horizontal, although a lack of parallelism between the arm 110 and the upper limb of the user might subsist. By generally horizontal, it should be understood an orientation generally parallel to the ground and generally orthogonal to the body of the user 200. Hence, the arm 110 and the upper limb are oriented forwards, when the user 200 is standing, in this characteristic position. This position is called “working” position because it corresponds to a position in which the user 200 carries a load in his hands, or handles a tool, for example.

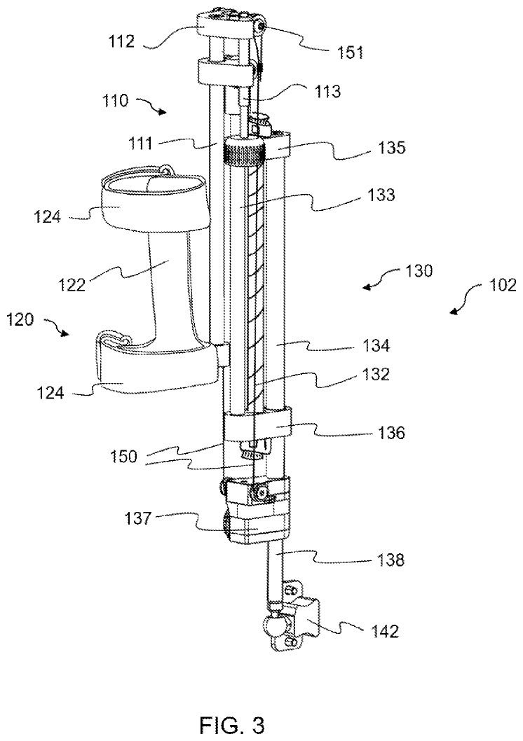

FIG. 3 represents the module 102 in a so-called “rest” or “low” first extreme position, in which the upper limb of the user 200 is generally vertical, i.e. generally orthogonal to the ground and generally parallel to the body of the user 200, and oriented downwards, when the user 200 is standing. This position is called “rest” position because it corresponds to a position in which the arms and the hands of the user 200 are aligned along the body downwards, generally not allowing the completion of a task or of an activity.

However, it should be noted that in this characteristic position, the arm 110 is not strictly vertical, but forms an angle between 0 and 45° with the arm of the upper limb of the user, in a plane parallel to the sagittal plane of the wearer. However, this position actually corresponds to an extreme position of the arm from a mechanical point of view, in which the exoskeleton is almost entirely stowed, as shown in FIG. 3.

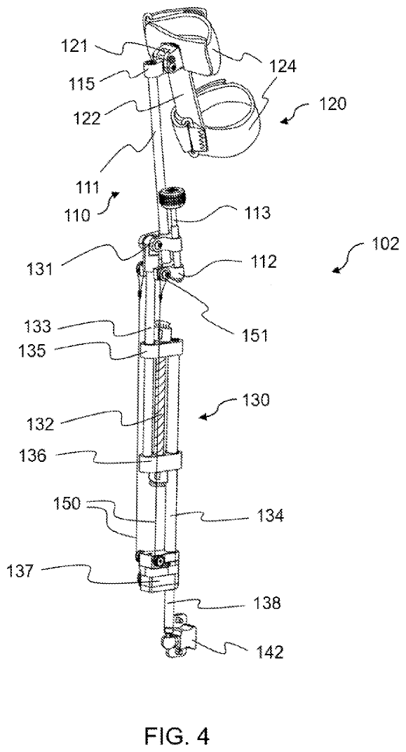

FIG. 4 represents the module 102 in a second so-called “high” extreme position, in which the upper limb of the user 200 is generally vertical, i.e. generally orthogonal to the ground and generally parallel to the body of the user 200, and oriented upwards, when the user 200 is standing. It is specified that this extreme “high” position is not strictly a vertical position of the arm 110, but a position located in an angular range between the vertical and about 15° forwards of this position. This so-called “high” position corresponds to a position in which the arms and the hands of the user 200 are substantially parallel to the body of the user and oriented upwards, for example to reach an object located at a height, or for using a tool above the user.

As shown in FIG. 4, the exoskeleton is not fully deployed in this extreme “high” position, in order to provide assistance to the user, even in this extreme position. In addition, this slight bending of the exoskeleton causes it to be stowed, i.e. to evolve towards a position close to the intermediate position.

Thus, it should be understood that the exoskeleton 100 is, in use, oriented according to the body of the user 200, the latter in his standing position and in particular in the so-called “working” position representing a reference system allowing identifying relative positions referred to as “high”, “low”, “front” and “rear”, as well as “upper” and “lower”.

As shown in FIGS. 2 to 4 in particular, the arm 110 of the module of the exoskeleton 100 includes a means 120 for attaching the upper limb 102 of the wearer 200. Thus, in use, the arm 110 of the exoskeleton is generally parallel to the upper limb 102, and more specifically parallel to the arm of said upper limb. However, a lack of parallelism appears in particular in positions close to the extreme “rest” and “high” positions.

A compensation member 130 with a generally longitudinal shape is pivotally secured to the arm 110, via a first simple pivot 131. The axis of the first pivot 131 is substantially perpendicular to the arm 131 and to the compensation member 130, as shown in FIG. 2 in particular. Notice that the reference 131 subsequently refers to the first pivot from a mechanical point of view but also the part on which the pivot point is arranged.

A load-bearing structure 140 including a support point 141 supports the compensation member 130, and by extension the arm 110.

In other words, the compensation member 130 is located between the load-bearing structure 140 and the arm 110.

Advantageously, the load-bearing structure 140 is a pelvic (or abdominal) belt, adapted to grip the hips and/or the waist of the wearer, depending on how the user wears the exoskeleton 100.

Advantageously, such a belt is made of textile material, and preferably includes at least one closure buckle, which may be adjustable. It is also possible to consider the belt including a setting buckle, advantageously located opposite the closure buckle, in order to increase the possible setting range.

In the present example, the support point 141 is a support plate 142 secured on the load-bearing structure 140 and provided with a spherical housing.

The compensation member 130 has at its so-called “low” end, i.e. at its end proximate to the load-bearing structure 140, a spherical head adapted to be inserted into the spherical housing of the support plate 142, so as to form together a ball-joint connection, enabling three independent degrees of rotation of the compensation member 130, relative to the load-bearing structure 140.

However, it is also possible, and even desirable in some combinations, to have only two, one, and possibly no degree of rotational freedom between the compensation member 130 and the load-bearing structure 140. In this case, the ball-joint connection may be replaced for example by a double pivot, a single pivot or embedding.

The compensation member 130 exerts a compensation force moment on the arm 110, the moment varying with the position of the upper limb 202, and therefore of the arm 110.

Advantageously, the compensation force moment is generated by the deformation of an elastic element 132 of the compensation member 130. Thus, it should be understood that the energy made available to the user is stored only in the elastic element 132 in the form of elastic energy, and that no other source of energy is necessary, thereby conferring great lightness, compactness and autonomy on the exoskeleton.

More particularly, a maximum compensation force moment is exerted when the upper limb 202 is located in the so-called intermediate “working” position. This feature is particularly advantageous to the extent that in this position, the user 200 requires the most assistance from the exoskeleton 100.

A first minimum compensation force moment is exerted when the upper limb 202 is located in the so-called called “rest” or “low” first extreme position.

A second minimum compensation force moment being exerted when the upper limb 202 is located in the so-called “high” second extreme position.

Advantageously, the two minimum compensation force moments are substantially equal to zero, so as not to exert any force on the user when his upper limb 202 is in one of the “high” or “low” positions.

Moreover, the force moment increases from the so-called “high” first extreme position up to the so-called “working” intermediate position and decreases from the so-called “working” intermediate position up to the so-called “rest” second extreme position. More specifically, the force moment is also monotonous respectively over the two aforementioned ranges, so as to supply a compensation force moment increasing continuously when switching from one of the two extreme positions into the intermediate position.

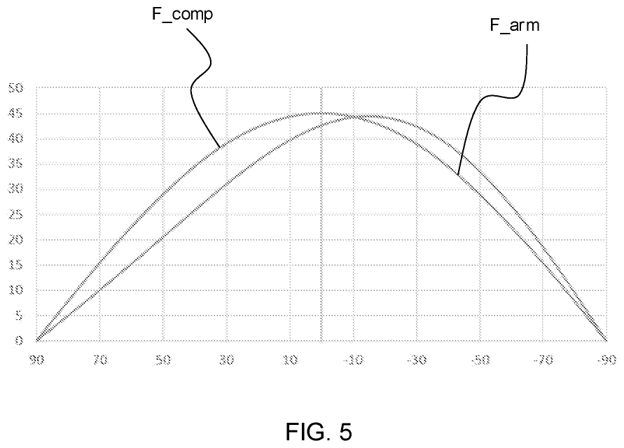

FIG. 5 illustrates the evolution of the compensation force F_comp exerted by the exoskeleton 100 on the upper limb 202 as a function of the angle of inclination of the arm 110 with respect to the horizontal. The force F_comp is an alternative representation of the compensation force moment, enabling immediate understanding of the compensation felt by the user.

Thus, in FIG. 5, where the compensation force F_comp, expressed in Newton [N], is represented as a function of the angle formed between the arm 110 and a horizontal axis, expressed in degrees, the maximum compensation force corresponds approximately to 45 N. In other words, in this example, the exoskeleton 100 is capable of compensating for a load with a mass slightly greater than 4.5 kilograms carried by the user (when the arm 110 is located at 0° with respect to the horizontal).

As shown in FIG. 5, the compensation force is zero at the extreme positions corresponding to an inclination of the arm 110 by +/−90° with respect to the horizontal.

It should be noted that FIG. 5 also illustrates the force F_arm exerted by the compensation member on the arm 110, whose maximum is slightly shifted towards the so-called “rest” position.

As mentioned before, the source of energy allowing generating the force moment during the movement of the upper limb 202 is the elastic element 132.

The elastic element 132 is located on the compensation member 130 which comprises, according to an advantageous embodiment, an upper bar 133 and a lower bar 134, these bars being parallel. An upper end of the lower bar 134 is secured to an upper plate 135 and a lower end of the upper bar 133 is secured to a lower plate 136. The upper bar 133 slides in an opening of the upper plate 135 and the lower bar 134 slides in an opening of the lower plate 136. In other words, the upper 133 and lower 134 bars can slide so as to be able to take on a plurality of positions between a retracted extreme state of the compensation member 130, in which they face each other over their entire length, and a deployed extreme state of the compensation member 130, in which the two plates are close to or in contact with one another.

The elastic element 132 extends between the upper plate 135 and the lower plate 136 to which it is secured, and preferably corresponds to a tension spring, and more preferably to an elastic cable. Thus, the switch from the retracted state into the deployed state of the compensation member 130 causes tensioning of the elastic element 132, in other words, the elastic element 132 tends to drive the compensation member 130 into the retracted state.

Alternatively, the compensation member 130 may be made more compact by using a rod sliding in a tube, the elastic element being secured on the one hand to an upper end of the tube and on the other hand to a lower end of the rod. Thus, a tension of the elastic element introduces a retraction of the rod in the tube, the compensation member being set in a compression state, seeking to return to a retracted state in which the elastic element is in a minimum tension state. This solution has the advantage of great compactness, the size being limited to the dimensions of a single tube and no longer two tubes.

Thus, it should be understood that the elastic element 132 is primarily stressed in tension, and that being so continuously during the use of the exoskeleton 100, so as to keep the exoskeleton 100 in a state of equilibrium. Other stresses, secondary and negligible, could yet appear, the connections between the elements not being mechanically perfect.

Advantageously, the elastic element 132 is an elastic cable including an elastic core, preferably made of rubber, and a protective sheath, preferably made of a woven material having an elastic capacity. Such cables are known in the prior art, in particular as cable or sling called “Sandow”.

The load exerts a force at the attachment means 120, and thus a force moment around the arm 110, the latter being rotatable.

In order to act against the force moment exerted by the load, a force transmission element 150, preferably with no elastic deformation capacity, extends between a low point of the compensation member 130 and a rear end of the arm 110 opposite to a front end of said arm 110.

More specifically, said low point of the compensation member is, in this embodiment, a lower fastening part 137 secured to a support bar 138 located between the lower plate 136 and the load-bearing structure 140. The support bar 138 is also provided at its so-called “low” end with the spherical head introduced hereinbefore.

The force transmission element 150 is attached to the rear end of the arm 110 using an upper fastening part secured to the arm 110, thereby forming a second pivot 151, about which the arm 110 can pivot. Said upper fastening part forms a notch that can fit around the upper bar 133, in order to increase the amplitude of movement of the arm 110, as shown in FIG. 4.

The force transmission element 150 may be a longitudinal rigid part such as a bar or a tube. However, the force transmission element 150 being preferably subjected to tensile stresses exclusively, the latter advantageously comprises a cable and elements for fastening the cable, making the exoskeleton 100 lighter and with a simpler design.

In particular, such a cable is a cable made of a metallic material, advantageously composed by braided steel wires, known in the prior art as so-called “Bowden” cables in particular. In its intended use in the present invention, such a cable may be considered as being generally non-deformable in tension in its longitudinal dimension, like a rigid element such as a rod or a tube and is similar to an elongated element substantially with no elastic deformation capacity.

As shown in FIGS. 2 to 4, the force transmission element 150 advantageously consists of two cables extending in parallel and symmetrically on either side of the compensation member 130.

Thus, it should be understood that the force transmission element 150 is primarily stressed in tension, and that being so continuously during the use of the exoskeleton 100, so as to keep the exoskeleton 100 in a state of equilibrium. Other stresses, secondary and negligible, could yet appear, the connections between the elements not being mechanically perfect.

Moreover, it is provided that the support bar 138 could be substantially retracted inside the part 134, which in this case is a lower tube rather than a lower bar. The lower fastening part 137 is secured to the lower tube 134 and allows adjusting the relative axial position of the support bar 138 and of the lower tube 134. For example, such an adjustable fastening is performed by bolting, advantageously provided with a knob to enable simplified setting without tools, and directly accessible to the user when the exoskeleton is worn.

It should be easily understood that, in particular in the intermediate position, the force transmission element holds the arm 110 tending to rotate about the first pivot 131, by taking up the moment generated by the load.

In turn, the force generated by the load is compensated by the elastic element 132, which generates a compensation force by deformation thereof.

During the movement of the arm 110, by the constant length of the force transmission element 150 and the kinematics of the exoskeleton 100, the compensation member 130 substantially retracts or deploys.

During a movement of the arm 110, the force exerted by the elastic element varies and reaches a maximum when the arm 110 is in a position corresponding to the so-called “low” position. However, the lever arm (orthogonal to the force exerted by the elastic element) formed between the first pivot 131 and the rear end of the arm 110 is then zero. Conversely, the minimum force exerted by the elastic element is reached in the so-called “high” position, in which it generally corresponds to the weight of the load, the assistance then being almost zero.

Indeed, in this high extreme position, the first pivot 131 and second pivot 151, as well as the point of application of the load represented by the part 115 are aligned, the lever arm of the compensation force then being zero.

Thus, it should be understood that the assistance provided by the exoskeleton is slightly greater in the range of positions between the “low” position and the “working” position, because of the greater force exerted by the elastic element 132 over this range.

As mentioned before, the compensation offered by the exoskeleton depends on the lever arm orthogonal to the force of the elastic element, formed between the first pivot 131 and the rear end of the arm 110, i.e. the distance between the first pivot 131 and the rear end of the arm 110.

The desired compensation depending on the type of activity, the load and the morphology of the user, the distance between the first pivot 131 and the rear end of the arm 110 is made adjustable via a setting mechanism of the arm 110.

Advantageously, the arm 110 is composed by a rod 111 able to slide into an opening of the first pivot 131, said opening being located on the portion of the first pivot secured to the arm 110.

The arm 110 includes a setting plate 112 at its rear end, which also includes (or is coincident with) the fastening part of the force transmission element 150.

A setting worm screw 113 is mounted so as to be able to rotate freely in the setting plate 112, without entering into translation relative to the latter.

The setting screw 113 cooperates with a threaded opening of the portion of the first pivot 131 secured to the arm 110, so that the screw 113 extends parallel to the arm 110.

Thus, the rotation of the screw 113 causes translation thereof relative to the first pivot 131, and thus a translation of the arm 110 relative to the first pivot 131, the arm 110 being secured to the screw 113 via the setting plate 112.

Such a setting mechanism is particularly easy to use and accessible to the user. Ease of use can be improved even more by providing the head of the screw 113 with a knob, avoiding the need for a tool for setting.

Advantageously, in order to reduce the torque exerted by the user on the screw head, necessary for setting, friction reduction elements are integrated into the setting mechanism. More specifically, the screw 113 may be supported by bearings, plain bearing, or lubricated bushings. In this manner, the lever arm can be set while the exoskeleton is in the working position, enabling setting in use and “in real-time”, in a particularly intuitive manner for the user.

As mentioned before, the upper limb 202, more particularly the arm, is secured on the attachment means 120. The attachment means 120 may be composed by a single brassiere secured to the arm 110, however it advantageously consists of a double and rigid brassiere.

To this end, a mounting bracket 115 secured on the front end of the arm 110 cooperates with a mounting clevis 121 of the attachment means 120. The bracket 115 and the clevis 121 are connected for example by bolting leaving a clearance, so as to enable a rotation of the attachment means relative to the arm 110. This rotation is limited to a given angular amplitude, in order to allow for a smooth switch from the so-called “rest” and “high” extreme positions into intermediate positions. For example, the limitation of the rotation is obtained by the use of a bolt parallel to the mounting bolting of the attachment means 120, so that said bolt abuts against the bracket 115 in a first extreme angular position. A second extreme angular position is defined by the longitudinal cushion introduced hereinafter, abutting against the arm 110.

The mounting clevis 121 is secured to a longitudinal cushion (rigid or soft) 122, advantageously enlarged at its end close to the elbow of the wearer, in use. Advantageously, the cushion 122 follows a portion of the arm of the upper limb, in the direction of the shoulder of the wearer.

In this manner, the arm of the user is supported over a major portion of its length and thus increases the comfort and efficiency of the exoskeleton 100.

In order to keep the arm of the user on the cushion 122, the latter is provided with at least one, and preferably two (or more) brassieres 124 preferably made of textile material, allowing attaching the upper limb 202 to the exoskeleton. Advantageously, such brassieres have two attachment bands comprising complementary securing means intended to cooperate with each other. These securing means may indifferently consist of elements in the form of hooks or elements in the form of buckles intended to cooperate with each other, the hooks hooking to the buckles, temporarily. Such securing means are known to a person skilled in the art as “Velcro®”, and allow adjusting the attachment to the morphology of the user.

The use of two (or more) brassieres 124 allows limiting the degrees of freedom of the arm of the upper limb relative to the attachment means 120. Indeed, the use of a single brassiere made of a flexible material leaves a great freedom of rotation to the upper limb on the attachment means 120, in other words the ball joint, or angular backlash, between the upper limb and the attachment means 120 is high. In this situation, the movements performed by the user, in other words the forces produced, are not entirely used to make the arm 120 of the exoskeleton pivot, nor does the latter closely follow the natural movement of the user. The use of at least two brassieres 124 separated by a non-zero distance thus allows increasing the comfort of use and the efficiency of the exoskeleton.

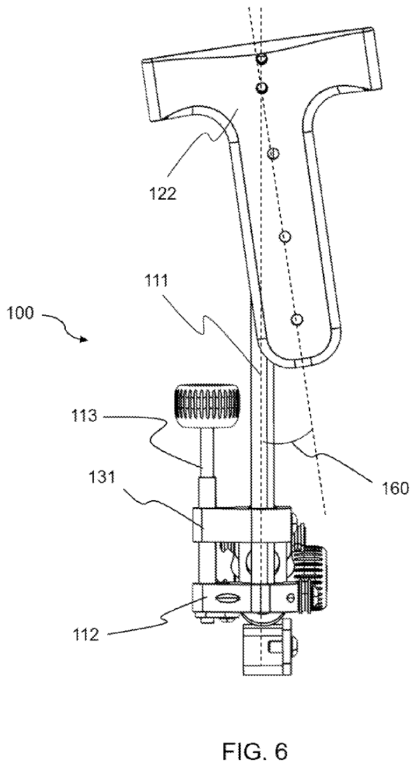

Advantageously, as shown in FIG. 6, the mounting bracket 115 is not aligned with the axis of the arm 110, but forms an angle 160 comprised between 0 and 30 degrees in a so-called “horizontal” plane (parallel to the ground) when the exoskeleton is in use in the “intermediate” or “working” position.

In other words, in the “working” position, the projection of the axis of symmetry of the attachment means 120, passing through the cushions 122, and the projection of the axis of the arm 110 on a horizontal plane intersect with an acute angle 160 comprised between 0 and 30 degrees.

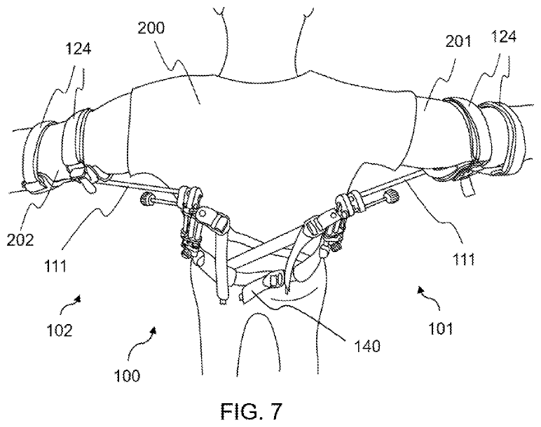

In this manner, the rear end of the arm 110 is oriented slightly away from the user, thereby avoiding collisions between the arm 110 and the sides of the user, as illustrated in FIG. 7.

According to an alternative embodiment, the exoskeleton according to the invention comprises a number of elastic elements greater than one.

Many combinations are possible, such that no exhaustive description of these combinations could be given, and it should be understood that any “self-stressed” type structure according to the same design principles is feasible.

For example, elastic elements 132 similar to tension springs are integrated in series and/or in parallel with the compensation member 130. The use of elastic elements 132 with a lower elastic constant and with smaller dimensions than in the previously-described preferred embodiment with a single elastic element allows, however, obtaining the same output behavior (illustrated in FIG. 5).

At equal performances, the advantage provided by this solution is a greater freedom of design in geometric terms, the compensation member 130 being able in this example to be curved in order to match with the shape of the body of the user.

According to one variant, the elastic constant and the length of the elastic elements 132 are different, so as to obtain an output behavior that is different from that illustrated in FIG. 5.

Thus, much more constant behaviors for positions around the working position can be obtained, i.e. the compensation force felt by the user is almost constant over an extended angular range. Such behavior may be desirable in the context of some activities, where the load does not vary according to the angle formed by the arm and the horizontal.

1-12. (canceled)

13. An exoskeleton adapted to assist at least one upper limb of a wearer of the exoskeleton when lifting and carrying a load, the exoskeleton comprising:
at least one arm comprising a front end and a rear end opposite the front end, and comprising at the front end at least one means for attaching the at least one upper limb of the wearer,
a load-bearing structure configured to be secured to the wearer and comprising at least one support point,
at least one compensation member secured to the at least one arm by a first pivot, extending between the at least one arm and the load-bearing structure to which the at least one compensation member is secured, and exerting a compensation moment of force on the at least one arm by a deformation of at least one elastic element, and
a force transmission element extending between a low point of the at least one compensation member and the rear end of the at least one arm,
wherein the at least one elastic element and the force transmission element are continuously loaded in tension during a use of the exoskeleton and are configured so that the compensation moment of force varies with an inclination of the at least one arm, the force transmission element being secured to the at least one arm by a second pivot located at the rear end, the first pivot being located between the second pivot and the front end.

14. The exoskeleton of claim 13, wherein the at least one arm comprises a setting mechanism for setting a distance between the first pivot and the second pivot.

15. The exoskeleton of claim 14, wherein the setting mechanism comprises:
an opening of the first pivot in which the at least one arm is able to slide, and
a setting plate located at one of the front end and the rear end of the at least one arm, the setting plate being secured to a worm screw cooperating with a threaded opening of the first pivot.

16. The exoskeleton of claim 13, wherein the at least one elastic element comprises:
a state of minimum tension when the at least one upper limb is located in a high first extreme position, and
a state of maximum tension when the at least one upper limb is located in a rest second extreme position,
wherein a tension of the at least one elastic element causes a retraction of the at least one compensation member, the at least one compensation member being in a deployed state when the at least one upper limb is located in the high first extreme position and in a maximum retracted state when the at least one upper limb is located in the rest second extreme position.

17. The exoskeleton of claim 13, wherein the at least one compensation member comprises:
an upper bar, and
a lower bar, parallel to the upper bar,
wherein an upper end of the lower bar is secured to an upper plate, a lower end of the upper bar is secured to a lower plate, the upper bar sliding in an opening of the upper plate and the lower bar sliding in an opening of the lower plate and wherein the at least one elastic element extends between the upper plate and the lower plate.

18. The exoskeleton of claim 13, wherein the at least one elastic element is an elastic cable including an elastic core, made of rubber, and a protective sheath, made of a woven material having an elastic capacity.

19. The exoskeleton of claim 13, wherein the force transmission element comprises an elongated element with no substantial elastic deformation capacity.

20. The exoskeleton of claim 19, wherein the force transmission element comprises two elongated elements extending parallel to one another on either side of the at least one compensation member.

21. The exoskeleton of claim 12 or claim 20, wherein the elongated element is a cable.

22. The exoskeleton of claim 13, wherein the at least one support point is a spherical housing and the at least one compensation member comprises a spherical head, so as to form a ball-joint connection.

23. The exoskeleton of claim 12, wherein the load-bearing structure is a pelvic belt adapted to grip hips of the wearer.

24. The exoskeleton of claim 13, wherein the load-bearing structure is a pelvic belt adapted to grip a waist of the wearer.

25. The exoskeleton of claim 13, wherein an attachment means comprises a longitudinal cushion, and wherein projections of an axis of the longitudinal cushion and of an axis of the at least one arm on a horizontal plane intersect at an angle comprised between 0 and 30 degrees, when the exoskeleton is located in a working position.
